(19) United States
(12) Patent Application Publication
(10) Pub. No.: US 2026/0189624 A1
(43) Pub. Date: Jul. 2, 2026

(54) METHOD OF TRANSMITTING DATA BY ELECTRONIC DEVICE TO SERVER AND SYSTEM THEREFOR

(71) Applicant: SAMSUNG ELECTRONICS CO., LTD., Suwon-si (KR)

(72) Inventors: Juyeon SHIM, Suwon-si (KR); Sangmook Lim, Suwon-si (KR); Myoungil Lee, Suwon-si (KR); Jieun Park, Suwon-si (KR)

(73) Assignee: SAMSUNG ELECTRONICS CO., LTD., Suwon-si (KR)

(21) Appl. No.: 19/530,745

(22) Filed: Feb. 5, 2026

Related U.S. Application Data
(63) Continuation of application No. PCT/KR2026/000085, filed on Jan. 2, 2025.

(30) Foreign Application Priority Data
Jan. 2, 2025 (KR) 10-2025-0000461

(51) Int. Cl. H04L 67/12; G06F 16/2458; H04L 47/24

(52) U.S. Cl. CPC H04L 67/12; G06F 16/2465; H04L 47/24

(57) ABSTRACT

A method for transmitting data to a server, the method being performed by an electronic device. The method including in response to an occurrence of an operation event, obtaining data related to the operation event. The method including generating a data block comprising the data related to the operation event. The method including comparing a data pattern included in the data block with a database in which an importance level of a plurality of data patterns are defined. The method including, based on a result of the comparison, determining an importance level of the data block. The method including, based on a data collection range corresponding to the importance level of the data block. The method including selecting a portion of data included in the data block; and transmitting the selected portion of data to the server.

### CROSS-REFERENCE TO RELATED APPLICATIONS

This application is a continuation of International Application PCT/KR 2026/000085, filed on Jan. 2, 2026, which is based on and claims priority to Korean Patent Application No. 10-2025-0000461, filed on Jan. 2, 2025, in the Korean Intellectual Property Office, the disclosure of which is incorporated by reference herein in their entireties.

### 1. Field

The disclosure relates to a method by which an electronic device transmits data to a server and a system for performing the method.

### BACKGROUND ART

### 2. Description of the Related Art

A manufacturer that produces and sells digital devices collects operation information and state information of a digital device from a server of the manufacturer with the consent of a consumer to remotely recognize an operating state and an error state of the digital device used by the consumer. The manufacturer may prevent an error of the digital device in advance and improve the function and performance of the digital device based on the information collected at the server. The collected information may include information related to whether the digital device is turned on properly and an operation performed after the digital device is turned on.

The server of the manufacturer checks whether the digital device is turned on properly when power is supplied, based on the collected information. Also, the server of the manufacturer checks whether each basic function of the digital device is properly performed when the digital device is turned on, based on the collected information. For example, the server of the manufacturer checks whether an input device of the digital device operates properly and whether a display of the digital device displays correctly.

Also, the manufacturer checks whether an operating system is property installed, whether required applications are properly executed, and an operating state and a state with an external connection device. However, as the number of digital devices reporting data increases, a large amount of traffic may be generated at the server according to the information collected, and costs for managing the traffic may also increase. Accordingly, there is a demand for a method of reducing traffic while maximizing the amount of necessary information collected at the server.

There are various methods for reducing traffic when storing operation information generated in a digital device and transmitting the operation information to a server. First, there is a data compression method that reduces the amount of traffic by compressing data sent from a digital device. The data compression method is effective for transmitting large files such as images or videos. However, when a lossless compression method is applied, compression efficiency is relatively low, and when a lossy compression method is applied, there is a limit to the amount of information that may be contained because the characteristics of each data are not considered. Second, there is a method of collecting data at regular time intervals, instead of collecting data every second. When the method of collecting data at regular time intervals is applied, there is a possibility that necessary information may be lost and it is difficult to apply the method to information requiring continuity. Third, there is a method of storing data in a digital device and transmitting the data to a server only when necessary. According to the third method, unnecessary traffic may be prevented, but a storage space requirement for the digital device may increase. Fourth, there is a method of reducing traffic by optimizing a communication protocol. For example, because a latest protocol such as Hypertext Transfer Protocol version 2 (HTTP/2) supports a multi-streaming function, more data may be transmitted at once, thereby reducing traffic.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

According to an embodiment of the disclosure, a method for transmitting data to a server. The method being performed by an electronic device. The method including, in response to an occurrence of an operation event, obtaining data related to the operation event. The method including generating a data block including the data related to the operation event. The method including comparing a data pattern included in the data block with a database in which an importance level of a plurality of data patterns are defined. The method including, based on a result of the comparison, determining an importance level of the data block. The method including, based on a data collection range corresponding to the importance level of the data block, selecting a portion of data included in the data block. The method including transmitting the selected portion of data to the server.

In an embodiment, the importance level of each data pattern of the plurality of data patterns is defined based on at least one of an occurrence frequency of each data pattern of the plurality of data patterns, an importance of a function related to each data pattern of the plurality of data patterns, or a collection amount of each data pattern of the plurality of data patterns.

In an embodiment, the importance level of each data pattern of the plurality of data patterns is defined to increase as the occurrence frequency of each data pattern of the plurality of data patterns decreases.

In an embodiment, the selecting the portion of data includes selecting data having a collection level included in the data collection range.

In an embodiment, the obtaining of the data related to the operation event includes: obtaining data logs related to the operation event; and according to a certain criterion, mapping a collection level to each data log of the data logs.

In an embodiment, the data block includes data logs corresponding to a plurality of collection levels.

In an embodiment, the method further includes determining the data collection range corresponding to the importance level of the data block. A number of at least one collection level included in the data collection range increases as the importance level of the data block increases.

In an embodiment, the method further includes storing the selected portion of data in a memory.

In an embodiment, the transmitting of the selected portion of data to the server includes transmitting the selected portion of data to the server by considering a traffic condition of the server.

In an embodiment, the method further includes receiving, from the server, the database; storing the database received from the server; when the electronic device is turned on, transmitting version information of the database to the server; receiving, from the server, a result of comparing a version of a latest database with a version of the database received from the server; and when the version of the latest database is different from the version of the database received from the server, downloading the latest database from the server.

In an embodiment, the determining of the importance level of the data block includes: when the data pattern included in the data block is a new data pattern not defined in the database, determining the importance level of the data block as a highest level.

According to an embodiment of the disclosure, an electronic device including: memory in which at least one instruction is stored; and at least one processor operatively coupled to the memory and including a processing circuit. The at least one instruction stored in the memory, when executed by the at least one processor individually or collectively, causes the electronic device to, in response to an occurrence of an operation event, obtain data related to the operation event; generate a data block including the data related to the operation event; compare a data pattern included in the data block with a database in which an importance level of a plurality of data patterns are defined; based on a result of the comparison, determine an importance level of the data block; based on a data collection range corresponding to the importance level of the data block, select a portion of data included in the data block; and transmit the selected portion of data to a server.

In an embodiment, the importance level of each data pattern of the plurality of data patterns is defined based on at least one of an occurrence frequency of each data pattern of the plurality of data patterns, an importance of a function related to each data pattern of the plurality of data patterns, or a collection amount of each data pattern of the plurality of data patterns.

In an embodiment, to select the portion of data includes to select data having a collection level included in the data collection range.

In an embodiment, the at least one instruction stored in the memory, when executed by the at least one processor individually or collectively, causes the electronic device to: obtain data logs related to the operation event, and, according to a certain criterion, map a collection level to each data log of the data logs.

In an embodiment, a number of at least one collection level included in the data collection range increases as the importance level of the data block increases.

In an embodiment, the at least one instruction stored in the memory, when executed by the at least one processor individually or collectively, causes the electronic device to store the selected portion of data in the memory.

In an embodiment, to transmit of the selected portion of data to the server includes to transmit the selected portion of data to the server by considering a traffic condition of the server.

In an embodiment, the at least one instruction stored in the memory, when executed by the at least one processor individually or collectively, causes the electronic device to: receive, from the server, the database; store the database received from the server; when the electronic device is turned on, transmit version information of the database to the server; receive, from the server, a result of comparing a version of a latest database with a version of the database received from the server; and when the version of the latest database is different from the version of the database received from the server, download the latest database from the server.

In an embodiment, to determine of the importance level of the data block includes to: when the data pattern included in the data block is a new data pattern not defined in the database, determine the importance level of the data block as a highest level.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing a data collection system, according to an embodiment of the disclosure.

FIG. 2 is a flowchart for describing a method by which an electronic device for transmitting data to a server, according to an embodiment of the disclosure.

FIG. 3 is a diagram for describing a database in which an importance level of each data pattern is defined, according to an embodiment of the disclosure.

FIG. 4 is a diagram for describing a type of a data log, according to an embodiment of the disclosure.

FIG. 5 is a diagram for describing a collection level, according to an embodiment of the disclosure.

FIG. 6 is a diagram for describing a data collection range, according to an embodiment of the disclosure.

FIG. 7 is a diagram for describing an operation in which an electronic device determines a data collection range corresponding to an importance level of a data block, according to an embodiment of the disclosure.

FIG. 8 is a diagram for describing an operation in which an electronic device selects a portion of data from among entire data included in a data block, according to an embodiment of the disclosure.

FIG. 9 is a flowchart for describing a method by which an electronic device maintains a database as a latest version, according to an embodiment of the disclosure.

FIG. 10 is a flowchart for describing a method by which a server manages a database, according to an embodiment of the disclosure.

FIG. 11 is a diagram for describing an operation in which a server updates a database, according to an embodiment of the disclosure.

FIG. 12 is a diagram for describing an operation in which a server classifies a data pattern into a plurality of sub-patterns, according to an embodiment of the disclosure.

FIG. 13 is a block diagram for describing a function of an electronic device, according to an embodiment of the disclosure.

FIG. 14 is a block diagram for describing functions of an electronic device and a server, according to an embodiment of the disclosure.

### DETAILED DESCRIPTION

The terms used herein will be briefly described, and an embodiment of the disclosure will be described in detail.

The terms used herein are general terms currently widely used in the art in consideration of functions in an embodiment of the disclosure, but the terms may vary according to the intention of one of ordinary skill in the art, precedents, or new technology in the art. Also, some terms may be arbitrarily selected by the applicant, and in this case, the meaning of the selected terms will be described in detail in the detailed description of an embodiment of the disclosure. Accordingly, the specific terms used herein should be defined based on the unique meanings thereof and the whole context of the disclosure.

Throughout the disclosure, the expression “at least one of a, b, or c” indicates only a, only b, only c, both a and b, both a and c, both b and c, all of a, b, and c, or variations thereof.

In the disclosure, when a portion “includes” an element, another element may be further included, rather than excluding the existence of the other element, unless otherwise described. Also, the term such as “unit” or “module” used herein refers to a unit that performs at least one function or operation, and the unit or the module may be implemented as hardware or software or as a combination of hardware and software.

It should be appreciated that the blocks in each flowchart and combinations of the flowcharts may be performed by one or more computer programs which include instructions. The one or more computer programs may be stored in a single memory or the one or more computer programs may be divided with different portions stored in different multiple memories.

It is to be understood that the singular forms (e.g., “a,” “an,” and “the”) include plural referents unless the context clearly dictates otherwise. Thus, for example, reference to “a component surface” includes reference to one or more of such surfaces.

Any of the functions or operations described herein may be processed by one processor or a combination of processors. One processor or a combination of processors is circuitry performing processing, and may include circuitry such as an application processor (AP), a communication processor (CP), a graphics processing unit (GPU), a neural processing unit (NPU) a microprocessor unit (MPU), a system on chip (SoC), or an integrated circuit (IC).

An embodiment of the disclosure will now be described more fully with reference to the accompanying drawings for one of ordinary skill in the art to be able to perform the embodiment of the disclosure without any difficulty. However, an embodiment of the disclosure may be implemented in many different forms and is not limited to the embodiment described herein. Also, in the drawings, parts irrelevant to the description are omitted in order to clearly describe an embodiment of the disclosure, and like reference numerals denote like elements throughout the disclosure.

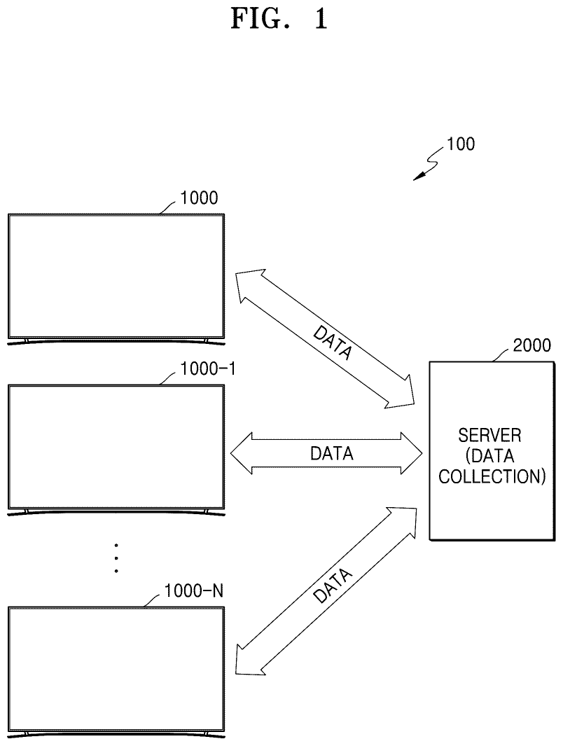

FIG. 1 is a diagram for describing a data collection system, according to an embodiment of the disclosure.

Referring to FIG. 1, a data collection system 100 according to an embodiment of the disclosure may include, but is not limited to, a plurality of electronic devices 1000, 1000-1, . . . , 1000-N and a server 2000.

The electronic device 1000 may be a device that has agreed to a data collection policy. For example, the electronic device 1000 may be a digital device that collects data related to an operation or a state (hereinafter, referred to as a data log) of the electronic device 1000 and transmits the collected data to the server 2000. The electronic device 1000 according to an embodiment of the disclosure may be implemented in various forms. Examples of the electronic device 1000 may include, but are not limited to, a display apparatus such as a TV, a monitor, a kiosk, or an advertisement screen, a home appliance such as a refrigerator, an air conditioner, an air purifier, or a robot vacuum cleaner, a laptop computer, a tablet PC, and a wearable device. For convenience of explanation, the following will be described assuming that the electronic device 1000 is a smart TV.

The electronic device 1000 may include a communication module configured to communicate with the server 2000, a user interface through which a user input is received or information is output to a user, at least one processor configured to control an operation of the electronic device 1000, and at least one memory in which a program for controlling an operation of the electronic device 1000 is stored.

The server 2000 may be a server that communicates with the plurality of electronic devices 1000, 1000-1, . . . , 1000-N and collects data transmitted from each of the plurality of electronic devices 1000, 1000-1, . . . , 1000-N.

The server 2000 may include a communication module configured to communicate with another server or the electronic device 1000, at least one processor capable of processing data received from another server or the electronic device 1000, and at least one memory in which a program for processing data or processed data may be stored. The server 2000 may be implemented as any of various computing devices such as a workstation, a cloud, a data drive, or a data station. The server 2000 may be implemented as one or more servers that are physically or logically separated based on functions, detailed configurations of functions, or data, and may transmit and receive data through communication between the servers and may process the transmitted and received data.

The server 2000 may perform functions such as managing user accounts, registering the electronic device 1000 associated with a user account, and managing or controlling the registered electronic device 1000. For example, a user may access the server 2000 through the electronic device 1000 and may create a user account. The user account may be identified by an ID and a password set by the user. The server 2000 may register the electronic device 1000 to the user account according to a pre-determined procedure. For example, the server 2000 may register, manage, and control the electronic device 1000 by connecting identification information (e.g., a serial number or a MAC address) of the electronic device 1000 to the user account.

The electronic device 1000 may be connected to the server 2000 through a network. The network may include both a wired network and a wireless network. The wired network may include a cable network or a telephone network, and the wireless network may include any network that transmits and receives a signal via radio waves. The wired network and the wireless network may be connected to each other.

The network may include a wide area network (WAN) such as the Internet, a local area network (LAN) formed around an access point (AP), and a short-range wireless network operating without passing through an AP. The short-range wireless network may include, but is not limited to, Bluetooth™ (IEEE 802.15.1), Zigbee (IEEE 802.15.4), Wi-Fi Direct, Near Field Communication (NFC), and Z-Wave.

The AP may connect the electronic device 1000 to the WAN to which the server 2000 is connected. The electronic device 1000 may be connected to the server 2000 through the WAN. The AP may communicate with the electronic device by using wireless communication such as Wi-Fi™ (IEEE 802.11), Bluetooth™ (IEEE 802.15.1), or Zigbee (IEEE 802.15.4) and may access the WAN by using wired communication, but the disclosure is not limited thereto.

Referring to FIG. 1, the server 2000 may collect data transmitted from each of the plurality of electronic devices in real time. When the number of the plurality of electronic devices 1000, 1000-1, . . . , 1000-N increases and the amount of data transmitted from each of the plurality of electronic devices 1000, 1000-1, . . . , 1000-N is large, a large amount of traffic may be generated, thereby overloading the server 2000 and causing a memory issue.

Accordingly, the electronic device 1000 according to an embodiment of the disclosure may adjust the amount of data collected related to each operation event according to an importance of a data pattern included in a data block corresponding to each operation event. The electronic device 1000 may transmit the differently collected data to the server 2000. For example, the electronic device 1000 may transmit simple information to the server 2000 for a data pattern that is frequently repeated or a data pattern related to a relatively less important function. The electronic device 1000 may transmit detailed information to the server 2000 for a data pattern that rarely occurs or a data pattern related to an important function. That is, because a sufficient amount of information related to the data pattern that is frequently repeated is already stored in the server 2000, simple information may be transmitted to reduce traffic of the server 2000. In contrast, because detailed analysis may be required by the server 2000 for the data pattern that infrequently occurs or the data pattern related to an important function, more detailed information may be transmitted to the server 2000. Accordingly, the electronic device 1000 according to an embodiment of the disclosure may provide the server 2000 with sufficient information required to analyze an operation and a state of the electronic device 1000 while reducing traffic.

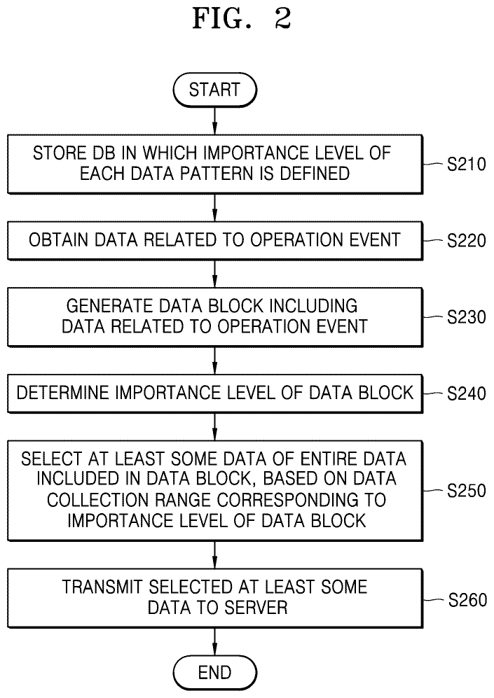

Hereinafter, a method by which the electronic device 1000 efficiently transmits data to the server 2000 will be described in detail with reference to FIG. 2.

FIG. 2 is a flowchart for describing a method performed by the electronic device 1000 for transmitting data to the server 2000, according to an embodiment of the disclosure.

Referring to FIG. 2, the method by which the electronic device 1000 transmits data to the server 2000 may include operations S210 to S260. In an embodiment of the disclosure, operations S210 to S260 may be performed by at least one processor included in the electronic device 1000. The method by which the electronic device 1000 transmits data to the server 2000 is not limited to that illustrated in FIG. 2, and in one or more embodiments of the disclosure, the method may further include operations not shown in FIG. 2 or some operations may be omitted.

In operation S210, the electronic device 1000 according to an embodiment of the disclosure may store a database in which an importance level of each data pattern of a plurality of data patterns received from the server 2000 is stored. For convenience of explanation, the database in which an importance level of each data pattern is defined may be referred to as an importance level database.

According to an embodiment of the disclosure, the electronic device 1000 may receive the importance level database, which is generated by the server 2000, from the server 2000 and may store the importance level database in a memory. The importance level database may be a table in which data patterns that may occur in the electronic device 1000 and an importance level corresponding to each data pattern are defined.

According to an embodiment of the disclosure, the importance level of each data pattern may be defined based on at least one of an occurrence frequency of each data pattern, an importance of a function related to each data pattern, or a collection amount of each data pattern. For example, the importance level of each data pattern may be defined to be higher as the occurrence frequency of the data pattern is lower, and may be defined to be lower as the occurrence frequency of the data pattern is higher. Also, a data pattern related to a critical error of the electronic device 1000 may be defined to have a high importance level. Also, the importance level of each data pattern may be defined to be lower as the amount collected by the server 2000 increases and may be defined to be higher as the amount collected by the server 2000 decreases.

A data pattern is related to operation data or state data generated in the electronic device 1000, and may include, but is not limited to, an error occurrence pattern, a normal operation pattern, an application execution pattern, a channel adjustment pattern, a key input pattern, an image playback pattern, a mode switching pattern, and an external device connection pattern.

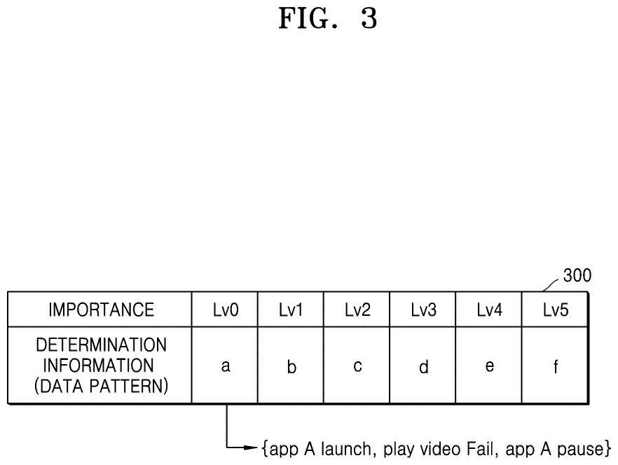

Referring to FIG. 3, for example, an importance level database 300 may include a first data pattern a (e.g., {app A launch, play video Fail, app A pause}), a second data pattern b, a third data pattern c, a fourth data pattern d, a fifth data pattern e, and a sixth data pattern f. The first data pattern a may be defined with a first importance level Lv0, the second data pattern b may be defined with a second importance level Lv1, the third data pattern c may be defined with a third importance level Lv2, the fourth data pattern d may be defined with a fourth importance level Lv3, the fifth data pattern e may be defined with a fifth importance level Lv4, and the sixth data pattern f may be defined with a sixth importance level Lv5. That is, the first data pattern a may have a lowest importance, and the sixth data pattern f may have a highest importance. When a pattern where application A launches, video playback fails during execution of application A, and the execution of application A pauses (app A launch, play video Fail, app A pause) frequently occurs, because a large amount of information related to the first data pattern a has been collected, the server 2000 may define an importance level of the first data pattern as the first importance level Lv0, which is the lowest importance level.

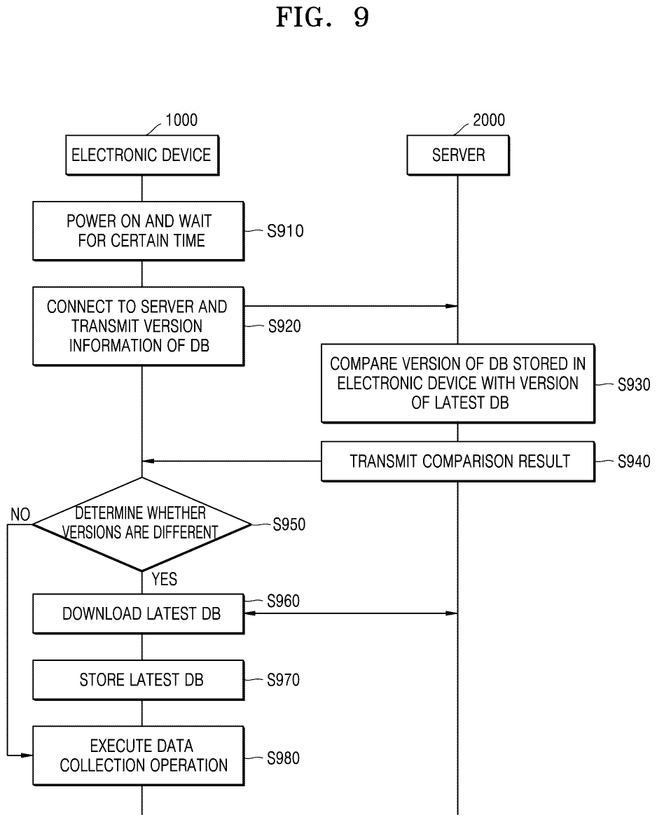

The importance level database 300 may be continuously updated by the server 2000, and the electronic device 1000 may maintain the importance level database 300 as a latest version. An operation in which the electronic device 1000 maintains the importance level database 300 as a latest version will be described below in detail with reference to FIG. 9.

According to an embodiment of the disclosure, the importance level database 300 may be stored in the memory of the electronic device 1000 during a process of manufacturing the electronic device 1000. Also, the importance level database 300 may be stored in the server 2000, and the electronic device 1000 may query only necessary information from the server 2000 and may use the necessary information.

Referring back to FIG. 2, in operation S220, in response to an occurrence of an operation event, the electronic device 1000 according to an embodiment of the disclosure may obtain data related to the operation event.

The operation event may refer to any of various operations occurring in the electronic device 1000. The operation event may refer to any of various operations or may include actions such as key input, channel change, audio adjustment, external device connection, video playback, playback error, application execution, mode switching, or screen splitting. An operation event may encompass any user interaction or system-triggered event within the electronic device 1000.

According to an embodiment of the disclosure, the data related to the operation event may include data logs related to the operation event. Accordingly, according to an embodiment of the disclosure, whenever an operation event occurs, the electronic device 1000 may obtain data logs related to the operation event.

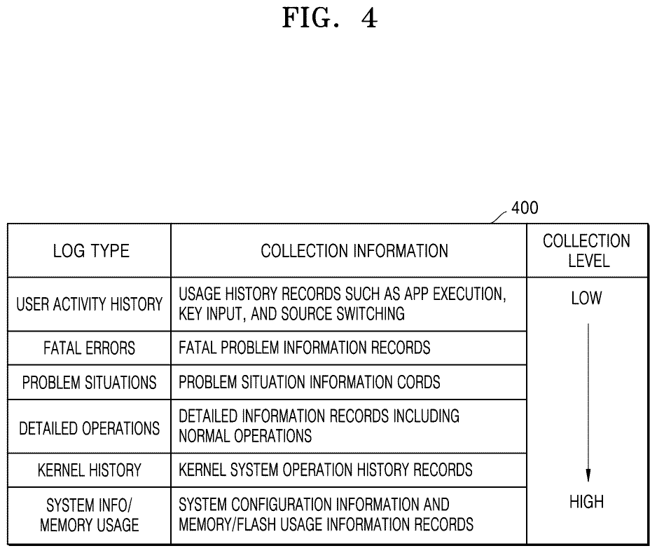

Referring to FIG. 4, data logs 400 may include, but are not limited to, usage history records, fatal problem information records, problem situation information records, detailed information records including normal operations, kernel system operation history records, system configuration information records, and memory usage information records.

According to an embodiment of the disclosure, a collection level may be predefined according to a type of a data log. Accordingly, the electronic device 1000 may map a collection level to each data log according to a certain criterion. The collection level may be a level defining a degree of detail of data. For example, a higher collection level may correspond to more detailed information. The collection level may be expressed as a converted data (CD) level.

Referring to FIG. 4, the collection level may increase as a type of a data log changes from usage activity history information to system information. For example, usage history records such as application execution, key input, and source switching may be predefined with a relatively low collection level, and system configuration information records may be predefined with a relatively high collection level.

In operation S230, the electronic device 1000 according to an embodiment of the disclosure may generate a data block including the data related to the operation event.

The data block may be generated whenever the operation event occurs. For example, the electronic device 1000 may generate data collected during operation as a data block. A size of each data block may vary according to the amount of data.

According to an embodiment of the disclosure, each data block may include data logs corresponding to a plurality of collection levels. For example, when an operation event of executing application Y occurs in the electronic device 1000, the electronic device 1000 may generate a data block including data logs having various collection levels related to execution of application Y.

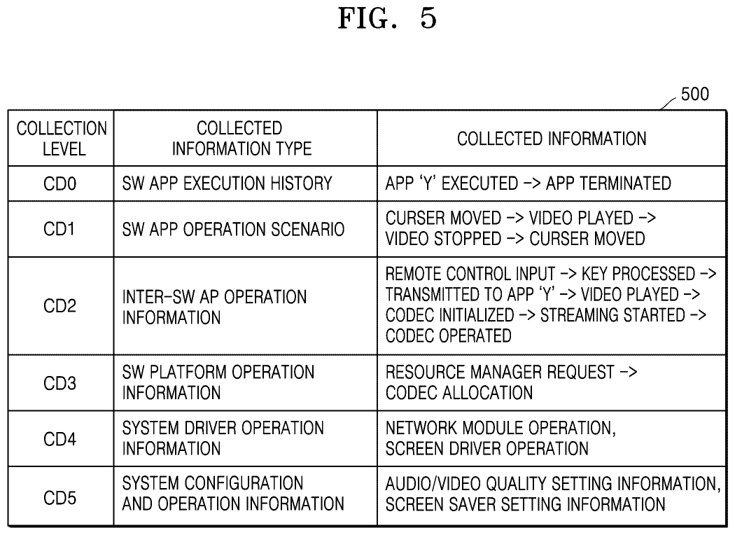

Referring to FIG. 5, a data block 500 corresponding to execution of application Y may include, but is not limited to, an application execution history log having a first collection level CD0 (e.g., app Y executed and app terminated), an application operation scenario log having a second collection level CD1 (e.g., curser moved, video played, video stopped, and curser moved), inter-application operation information having a third collection level CD2 (e.g., remote control input, key processed, transmitted to app Y, video played, codec initialized, streaming started, and codec operated), platform operation information having a fourth collection level CD3 (e.g., resource manager request and codec allocation), system driver operation information having a fifth collection level CD4 (e.g., network module operation and screen driver operation), and system configuration and operation information having a sixth collection level CD5 (e.g., audio/video quality setting information and screen saver setting information).

Referring back to FIG. 2, in operation S240, the electronic device 1000 according to an embodiment of the disclosure may determine an importance level of the data block, based on a result of comparing a data pattern included in the data block with the database in which an importance level of each data pattern is defined (hereinafter, importance level database 300).

According to an embodiment of the disclosure, the electronic device 1000 may search for an importance level of the data pattern included in the data block in the importance level database 300. The electronic device 1000 may search for a pattern that matches the data pattern included in the data block from among data patterns defined in the importance level database 300. Referring to FIG. 3, when the first data pattern (e.g., app A launch, play video Fail, app A Pause) among the data patterns defined in the importance level database 300 is included in the data block, the electronic device 1000 may determine an importance level of the data block as the first importance level Lv0 corresponding to the first data pattern.

According to an embodiment of the disclosure, when the data pattern included in the data block is a new data pattern not defined in the importance level database 300, the electronic device 1000 may determine an importance level of the data block as a highest level. When a new data pattern occurs, because detailed analysis may be required by the server 2000, the electronic device 1000 may determine an importance level of the data block as a highest level in order to transmit detailed information related to the new data pattern to the server 2000.

In operation S250, the electronic device 1000 according to an embodiment of the disclosure may select a portion of data included in the data block, based on a data collection range corresponding to the importance level of the data block.

According to an embodiment of the disclosure, the electronic device 1000 may determine the data collection range corresponding to the importance level of the data block. The data collection range may increase as the importance level of the data block increases, and the data collection range may decrease as the importance level of the data block decreases. When the data collection range is large, relatively detailed information may be transmitted to the server 2000, and when the data collection range is small, relatively simple information may be transmitted to the server 2000. Accordingly, as the data collection range increases, data logs of various collection levels may be transmitted to the server 2000.

According to an embodiment of the disclosure, as the data collection range increases, the number (types) of collection levels corresponding to the data collection range may increase. That is, the number of at least one collection level included in the data collection range may increase as the importance level of the data block increases.

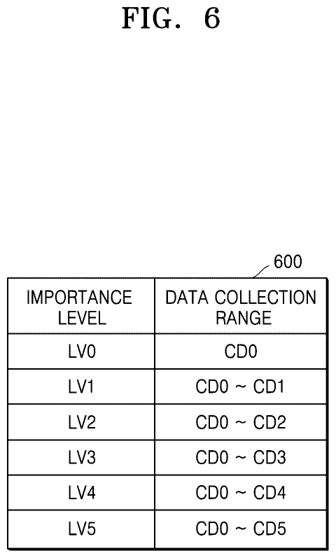

Referring to FIG. 6, as shown in table 600, when the importance level of the data block is the first level Lv0, the data collection range of the data block may be a data log having the first collection level CD0. When the importance level of the data block is the second level Lv1, the data collection range of the data block may be data logs having the first collection level CD0 and the second collection level CD1. When the importance level of the data block is the third level Lv2, the data collection range of the data block may be data logs having the first collection level CD0 to the third collection level CD2. When the importance level of the data block is the fourth level Lv3, the data collection range of the data block may be data logs having the first collection level CD0 to the fourth collection level CD3. When the importance level of the data block is the fifth level Lv4, the data collection range of the data block may be data logs having the first collection level CD0 to the fifth collection level CD4. When the importance level of the data block is the sixth level Lv5, the data collection range of the data block may be data logs having the first collection level CD0 to the sixth collection level CD5.

Accordingly, as the importance level of the data block increases, the amount of data selected in the data block may increase. For example, when the importance level of the data block is low, the electronic device 1000 may select simple data such as an operation identification code, but when the importance level of the data block is high, the electronic device 1000 may select detailed data including application execution history, kernel system operation history, and system configuration information history in addition to the operation identification code.

Although the table 600 shows that the data collection range for a higher importance level includes all data from a lower importance level, the embodiments of this disclosure are not limited to this configuration. For instance, a higher importance level's data collection range may exclude some data found in the lower importance level's range, while still containing more data overall.

Referring back to FIG. 2, in operation S260, the electronic device 1000 may transmit the selected portion of data to the server 2000.

According to an embodiment of the disclosure, because the electronic device 1000 selectively collects and transmits data to the server 2000 according to an importance level of each data block, traffic may be reduced. Also, because detailed information is transmitted to the server 2000 for a data block having a high importance level, the server 2000 may sufficiently analyze an operation and a state of the electronic device 1000.

According to an embodiment of the disclosure, the electronic device 1000 may transmit selected portion of data to the server 2000 by considering a traffic condition of the server 2000. For example, the electronic device 1000 may check network traffic information of the server 2000, and may delay transmission of the selected portion of data to the server 2000 when traffic is heavy. When traffic is low, the electronic device 1000 may transmit the selected portion of data to the server 2000 in real time.

According to an embodiment of the disclosure, the electronic device 1000 may store the selected portion of data in the memory before transmitting the selected portion of data to the server 2000. For example, the electronic device 1000 may select and store data logs corresponding to the importance level of the data block in the data block. That is, the electronic device 1000 may store only necessary data from the data block and may discard the rest to reduce the amount of stored data. According to an embodiment of the disclosure, when new data is stored, the electronic device 1000 may delete old data by considering a memory capacity.

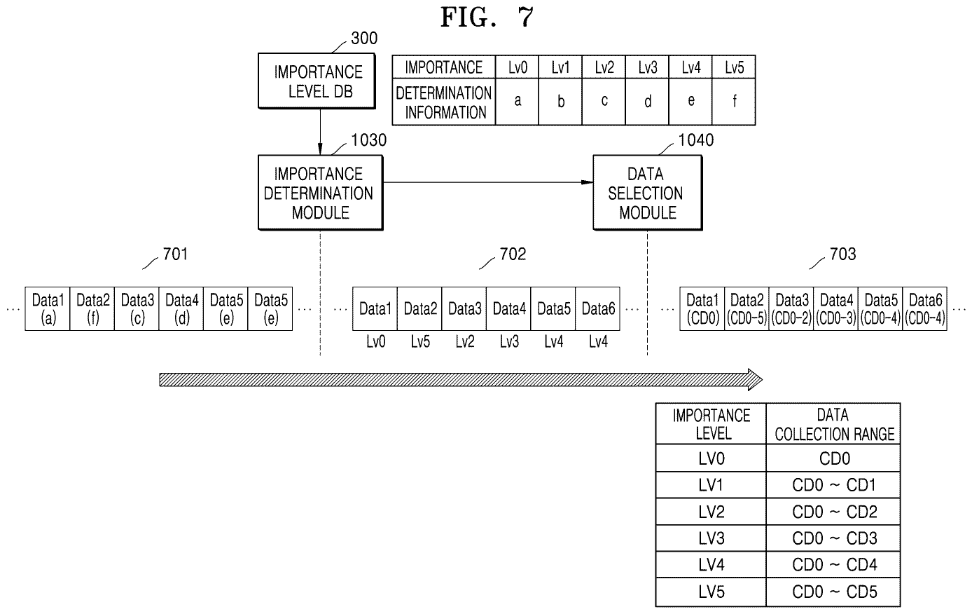

Hereinafter, an operation in which the electronic device 1000 selectively transmits data to the server 2000 by using the importance level database 300 will be described in more detail with reference to FIG. 7.

FIG. 7 is a diagram for describing an operation in which the electronic device 1000 determines a data collection range corresponding to an importance level of a data block, according to an embodiment of the disclosure.

Referring to 701 of FIG. 7, when the electronic device 1000 is turned on and begins to operate, the electronic device 1000 may generate data related to each operation event as a data block. For example, the electronic device 1000 may generate a first data block Data1 corresponding to a first operation event, a second data block Data2 corresponding to a second operation event, a third data block Data3 corresponding to a third operation event, a fourth data block Data4 corresponding to a fourth operation event, a fifth data block Data5 corresponding to a fifth operation event, and a sixth data block Data6 corresponding to a sixth operation event. In this case, a data pattern (a) may be included in the first data block Data1, a data pattern (f) may be included in the second data block Data2, a data pattern (c) may be included in the third data block Data3, a data pattern (d) may be included in the fourth data block Data4, a data pattern (e) may be included in the fifth data block Data5, and the data pattern (e) may be included in the sixth data block Data6.

Referring to 702 of FIG. 7, an importance determination module 1030 of the electronic device 1000 may determine an importance level of each data block, based on the importance level database 300 obtained from the server 2000. For example, because the data pattern (a) is included in the first data block Data1, the electronic device 1000 may determine an importance level of the first data block Data1 as a first level Lv0 corresponding to the data pattern (a). Because the data pattern (f) is included in the second data block Data2, the electronic device 1000 may determine an importance level of the second data block Data2 as a sixth level Lv5 corresponding to the data pattern (f). Because the data pattern (c) is included in the third data block Data3, the electronic device 1000 may determine an importance level of the third data block Data3 as a third level Lv2 corresponding to the data pattern (c). Because the data pattern (d) is included in the fourth data block Data4, the electronic device 1000 may determine an importance level of the fourth data block Data4 as a fourth level Lv3 corresponding to the data pattern (d). Because the data pattern (e) is included in the fifth data block Data5, the electronic device 1000 may determine an importance level of the fifth data block Data5 as a fifth level Lv4 corresponding to the data pattern (e). Because the data pattern (e) is included in the sixth data block Data6, the electronic device 1000 may determine an importance level of the sixth data block Data6 as the fifth level Lv4 corresponding to the data pattern (e).

Referring to 703 of FIG. 7, a data selection module 1040 of the electronic device 1000 may select a portion of data in the data block according to a data collection range corresponding to the importance level of the data block. For example, because the importance level of the first data block Data1 is the first level Lv0, the electronic device 1000 may select only a data log having the first collection level CD0 from among data logs included in the first data block Data1. Because the importance level of the second data block Data2 is the sixth level Lv5, the electronic device 1000 may select data logs having the first collection level CD0 to the sixth collection level CD5 from among data logs included in the second data block Data2. Because the importance level of the third data block Data3 is the third level Lv2, the electronic device 1000 may select data logs having the first collection level CD0 to the third collection level CD2 from among data logs included in the third data block Data3. Because the importance level of the fourth data block Data4 is the fourth level Lv3, the electronic device 1000 may select data logs having the first collection level CD0 to the fourth collection level CD3 from among data logs included in the fourth data block Data4. Because the importance level of the fifth data block Data5 is the fifth level Lv4, the electronic device 1000 may select data logs having the first collection level CD0 to the fifth collection level CD4 from among data logs included in the fifth data block Data5. Because the importance level of the sixth data block Data6 is the fifth level Lv4, the electronic device 1000 may select data logs having the first collection level CD0 to the fifth collection level CD4 from among data logs included in the sixth data block Data6.

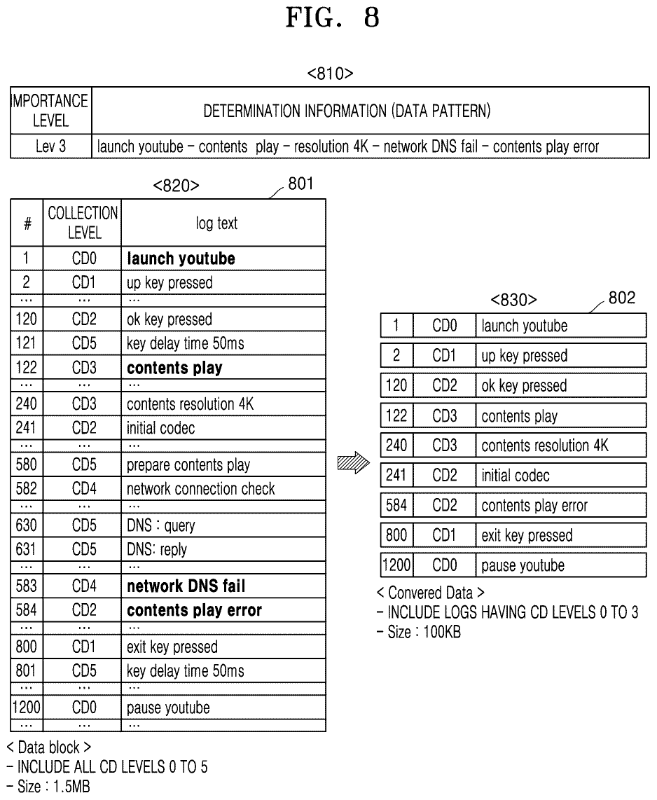

Because the electronic device 1000 transmits only data selected according to an importance level in each data block to the server 2000 without transmitting entire data of each data block, traffic may be reduced. Also, because detailed data may be collected from a data block having a high importance level and simple data may be collected from a data block having a low importance level, the server 2000 may efficiently detect an operation and a state of the electronic device 1000. An operation in which the electronic device 1000 selects a portion of data from a data block will be described in more detail with reference to FIG. 8.

FIG. 8 is a diagram for describing an operation in which the electronic device 1000 selects data portion of data from among entire data included in a data block, according to an embodiment of the disclosure.

Referring to 810 of FIG. 8, an importance level of a first data pattern (e.g., launch youtube-contents play-resolution 4K-network DNS fail-contents play error) may be defined as a fourth level Lev3 in the importance level database 300.

Referring to 820 of FIG. 8, the electronic device 1000 may generate a data block 801 related to an execution operation of application Y (e.g., Youtube™). The data block 801 may include data logs corresponding to various collection levels. For example, the data block 801 may include a first data log (e.g., launch youtube) mapped to the first collection level CD0, a second data log (e.g., Up key pressed) mapped to the second collection level CD1, a 121st data log (e.g., Key delay time 50 ms) mapped to the sixth collection level CD5, and a 122nd data log (e.g., contents play) mapped to the fourth collection level CD3. In this case, a size of the data block 801 may be 1.5 MB.

The electronic device 1000 may identify a data pattern that matches the first data pattern (e.g., launch youtube-contents play-resolution 4K-network DNS fail-contents play error) of the importance level database 300 in the data block 801. In this case, the electronic device 1000 may determine an importance level of the data block 801 as the fourth level Lev3 corresponding to the first data pattern.

Referring to 830 of FIG. 8, the electronic device 1000 may select some data from among entire data included in the data block 801, based on a data collection range corresponding to the importance level of the data block 801. Because the importance level of the data block 801 is the fourth level Lev3, the electronic device 1000 may select data logs having the first collection level CD0 to the fourth collection level CD3. The electronic device 1000 may generate converted data 802 including the data logs having the first collection level CD0 to the fourth collection level CD3. The converted data 802 may refer to data to be transmitted to the server 2000. In this case, a size of the converted data 802 may be 100 KB. The electronic device 1000 may store the converted data 802 in a memory and may transmit the converted data 802 to the server 2000.

According to an embodiment of the disclosure, because the electronic device 1000 selects and transmits a portion of data (100 KB) within the data collection range corresponding to the importance level to the server 2000, instead of transmitting entire data (1.5 MB) included in the data block 801 to the server 2000, traffic may be reduced and a required memory storage capacity may be reduced.

FIG. 9 is a flowchart for describing a method by which the electronic device 1000 maintains the database as a latest version, according to an embodiment of the disclosure.

Referring to FIG. 9, a method by which the electronic device 1000 maintains the database 300 as a latest version may include operations S910 to S980. In an embodiment of the disclosure, operations S910, S920, and S950 to S980 may be executed by at least one processor included in the electronic device 1000, and operations S930 and S940 may be executed by at least one processor included in the server 2000. The method by which the electronic device 1000 maintains the database 300 as a latest version is not limited to that illustrated in FIG. 9, and in one or more embodiments of the disclosure, the method may further include operations not shown in FIG. 9 or some operations may be omitted.

In operation S910, the electronic device 1000 according to an embodiment of the disclosure may be turned on and wait for a certain period of time. For example, when the electronic device is turned on, the electronic device 1000 may initialize a system for a period of time.

In operation S920, the electronic device 1000 according to an embodiment may connect to the server 2000. For example, when the electronic device 1000 is turned on and a certain period of time elapses, the electronic device 1000 may attempt to connect to the server 2000.

According to an embodiment of the disclosure, when the electronic device 1000 is connected to the server 2000, the electronic device 1000 may transmit version information of a database (hereinafter, referred to as importance level database) 300, defining an importance level of each data pattern currently stored in a memory, to the server 2000. According to an embodiment of the disclosure, the electronic device 1000 may transmit identification information (e.g., model name and region name) of the electronic device 1000 together with the version information to the server 2000.

In operation S930, the server 2000 according to an embodiment of the disclosure may compare a version of the importance level database 300 stored in the electronic device 1000 with a version of a latest importance level database stored in the server 2000.

In operation S940, the server 2000 may transmit a result of comparing the version of the importance level database 300 stored in the electronic device 1000 with the version of the latest importance level database stored in the server 2000 to the electronic device 1000.

According to an embodiment of the disclosure, the server 2000 may transmit, to the electronic device 1000, whether it is necessary to update the importance level database 300 stored in the electronic device 1000. When the version of the importance level database 300 stored in the electronic device 1000 and the version of the latest importance level database stored in the server 2000 are different from each other, the server 2000 may transmit information indicating that it is necessary to update to the electronic device 1000. When the version of the importance level database 300 stored in the electronic device 1000 and the version of the latest importance level database stored in the server 2000 are the same, the server 2000 may transmit information indicating that it is not necessary to update to the electronic device 1000.

In operation S950, when the electronic device 1000 according to an embodiment of the disclosure receives information indicating that it is necessary to update the importance level database 300 from the server 2000, the electronic device 1000 may determine that the version of the importance level database 300 stored in the electronic device 1000 and the version of the latest importance level database stored in the server 2000 are different from each other.

In contrast, when the electronic device 1000 receives information indicating that it is not necessary to update the importance level database 300 from the server 2000, the electronic device 1000 may determine that the version of the importance level database 300 stored in the electronic device 1000 and the version of the latest importance level database stored in the server 2000 are the same. When the version of the importance level database 300 stored in the electronic device 1000 and the version of the latest importance level database stored in the server 2000 are the same (No in operation S950), the electronic device 1000 may perform a data collection operation based on the importance level database 300 currently stored in the memory (operation S980). For example, the electronic device 1000 may determine an importance level of a data block according to whether a data pattern included in the data block matches the importance level database 300 currently stored in the memory, and may select and store a portion of data included in the data block according to the importance level of the data block.

In operation S960, when the version of the importance level database 300 stored in the electronic device 1000 and the version of the latest importance level database stored in the server 2000 are different from each other (Yes in operation S950), the electronic device 1000 according to an embodiment of the disclosure may download the latest importance level database from the server 2000.

In operation S970, the electronic device 1000 according to an embodiment of the disclosure may store the latest importance level database, instead of the current importance level database 300.

In operation S980, the electronic device 1000 according to an embodiment of the disclosure may perform a data collection operation based on the latest importance level database. For example, when an operation event occurs, the electronic device 1000 may generate a data block corresponding to data logs corresponding to the operation event, and may determine an importance level of the data block based on the latest importance level database. The electronic device 1000 may select a portion of data in the data block according to the importance level of the data block and may transmit the portion of data to the server 2000.

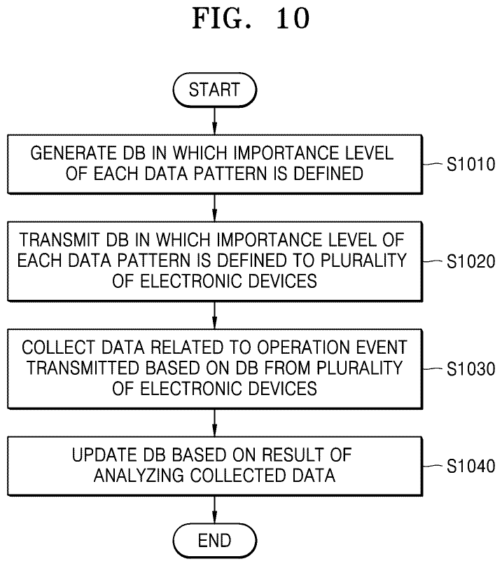

According to an embodiment of the disclosure, because the electronic device 1000 determines whether there is the latest importance level database in the server 2000 whenever the electronic device 1000 is turned on, and maintains the importance level database 300 as a latest version, the electronic device 1000 may adaptively reflect a data collection policy of the server 2000. According to an embodiment of the disclosure, the server 2000 may continuously update the importance level database 300 in order to efficiently collect data from the electronic device 1000. Hereinafter, a method by which the server 2000 updates the importance level database 300 will be described in detail with reference to FIG. 10.

FIG. 10 is a flowchart for describing a method by which the server 2000 manages a database, according to an embodiment of the disclosure.

Referring to FIG. 10, a method by which the server 2000 manages a database may include operations S1010 to S1040. In an embodiment of the disclosure, operations S1010 to S1040 may be executed by at least one processor included in the server 2000. The method by which the server 2000 manages a database is not limited to that illustrated in FIG. 10, and in one or more embodiments of the disclosure, the method may further include operations not shown in FIG. 10 or some operations may be omitted.

In operation S1010, the server 2000 according to an embodiment of the disclosure may generate a database (hereinafter, referred to as importance level database) 300 in which an importance level of each data pattern is defined.

According to an embodiment of the disclosure, the server 2000 may define a data pattern expected to occur in the electronic device 1000. The server 2000 may generate the importance level database 300 by defining an importance level of each data pattern of a plurality of data patterns by predicting an occurrence frequency of each data pattern, an importance of a function related to each data pattern, or a collection amount of each data pattern.

For example, the server 2000 may define an importance level of a data pattern having a low occurrence frequency to be higher than an importance level of a data pattern having a high occurrence frequency, and may define an importance level of a data pattern related to a primary function to be higher than an importance level of a data pattern related to a secondary function. Because detailed analysis may be required for a data pattern having a low occurrence frequency or a data pattern related to an important function of the electronic device 1000, the server 2000 may define a high importance level for the data pattern having a low occurrence frequency or the data pattern related to an important function, thereby allowing detailed information to be collected from the electronic device 1000. In contrast, the server 2000 may define a low importance level for a data pattern having a high occurrence frequency or a data pattern related to a secondary function of the electronic device 1000 so that simple information is collected from the electronic device 1000, thereby reducing traffic.

In operation S1020, the server 2000 according to an embodiment of the disclosure may transmit the importance level database 300 to a plurality of electronic devices.

According to an embodiment of the disclosure, the server 2000 may transmit the importance level database 300 to each of the plurality of electronic devices that have agreed to a data collection policy. The plurality of electronic devices may be of the same model, but the disclosure is not limited thereto.

According to an embodiment of the disclosure, the server 2000 may select some electronic devices from among the plurality of electronic devices and may transmit the importance level database 300. For example, when 100,000 TVs of the same model are released, the server 2000 may sample 10,000 TVs from among the 100,000 TVs and may transmit the importance level database 300. When 100,000 TVs of a new model are released, the server 2000 may transmit the importance level database 300 to all of the 100,000 TVs.

In operation S1030, the server 2000 according to an embodiment of the disclosure may collect data related to an operation event transmitted based on the importance level database 300 from the plurality of electronic devices.

Each of the plurality of electronic devices receiving the importance level database 300 from the server 2000 may store the importance level database 300 in a memory. Whenever an operation event occurs, each of the plurality of electronic devices may generate a data block including data related to the operation event, and may determine an importance level of the data block by using the importance level database 300. Each of the plurality of electronic devices may select a portion of data from among entire data included in the data block and may transmit the portion of data to the server 2000, based on a data collection range corresponding to the importance level of the data block. An operation in which each of the plurality of electronic devices transmits data related to an operation event based on the importance level database 300 has been described with reference to FIG. 2, and thus, a repeated description thereof will be omitted.

Accordingly, the server 2000 may collect detailed data for an operation event having a high importance, and may collect simple data for an operation event having a low importance. An operation event having a high importance may refer to an operation event requiring detailed data.

In operation S1040, the server 2000 according to an embodiment of the disclosure may update the importance level database 300 based on a result of analyzing the collected data. For example, the server 2000 may update the importance level database 300 by adjusting an importance level of each data pattern based on the result of analyzing the collected data.

According to an embodiment of the disclosure, the server 2000 may identify an occurrence frequency of each data pattern by analyzing the collected data. The server 2000 may adjust an importance level of each data pattern based on the occurrence frequency of each data pattern. For example, in the case of a data pattern that frequently occurs, because sufficient data is accumulated in the server 2000, it is not necessary to continuously collect a large amount of the same data. Accordingly, the server 2000 may reduce traffic by lowering an importance level of the data pattern that frequently occurs. In contrast, in the case of a data pattern that rarely occurs, because there is insufficient data in the server 2000, the server 2000 may increase an importance level to collect detailed data.

According to an embodiment of the disclosure, the server 2000 may identify a new data pattern that is not defined in the importance level database 300, by analyzing the collected data. In this case, the server 2000 may set an importance level of the new data pattern to a highest level, and may add the data pattern to the importance level database 300. For the new data pattern, because there is not much data and detailed analysis may be required in the future, the server 2000 may define an importance level to be a highest level in order to collect detailed information for the new data pattern.

However, when the new data pattern is related to a secondary function of the electronic device 1000 or is slightly different from an existing data pattern, an importance level may be defined to be low.

According to an embodiment of the disclosure. the server 2000 may analyze the collected data and classify a specific data pattern defined in the importance level database 300 into a plurality of sub-patterns. In this case, the server 2000 may define an importance level corresponding to each of the plurality of sub-patterns. For example, when it is efficient to sub-divide a specific data pattern as a result of analyzing the data collected from the plurality of electronic devices, the server 2000 may classify the specific data pattern into a plurality of sub-patterns. The server 2000 may newly define an importance level of each sub-pattern in the importance level database 300, by considering an occurrence frequency of each sub-pattern, an importance of a function related to each sub-pattern, or a collection amount of each sub-pattern.

According to an embodiment of the disclosure, the server 2000 may transmit the updated importance level database 300 to the plurality of electronic devices. For example, when each of the plurality of electronic devices is turned on, each electronic device may connect to the server 2000 and may transmit version information of the importance level database 300 stored in the memory. The server 2000 may compare a version of the importance level database 300 stored in each electronic device with a version of the updated importance level database 300, and when the version of the updated importance level database 300 is newer than the version of the importance level database 300 stored in each electronic device, the server 2000 may transmit information indicating that it is necessary to update the importance level database 300 to each electronic device. In this case, each electronic device may download the updated importance level database 300 from the server 2000. An operation in which each electronic device maintains the importance level database 300 in a latest state has been described with reference to FIG. 9, and thus, a repeated description thereof will be omitted.

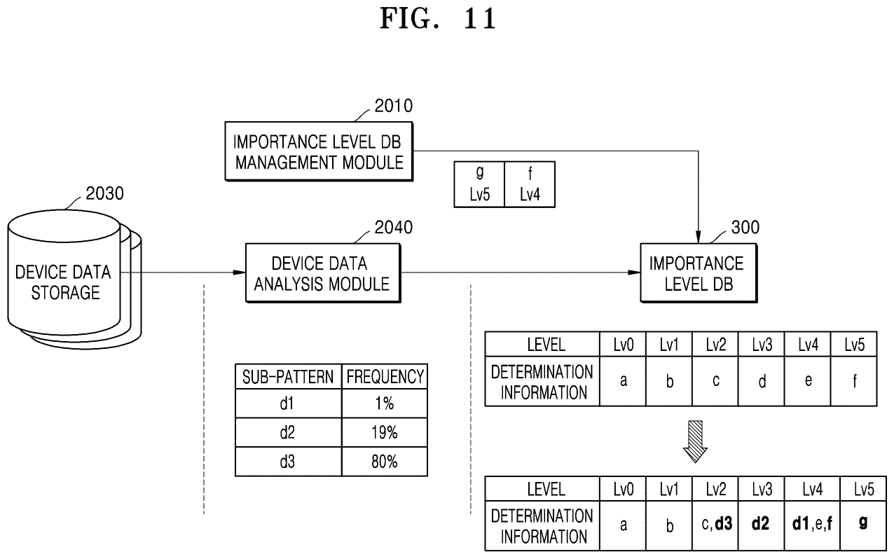

According to an embodiment of the disclosure. because the server 2000 continuously updates the importance level database 300 based on actual data collected from the plurality of electronic devices, collected data may have an optimal amount of information. Hereinafter, an operation in which the server 2000 updates the importance level database 300 will be described in more detail with reference to FIG. 11.

FIG. 11 is a diagram for describing an operation in which the server 2000 updates a database, according to an embodiment of the disclosure.

Referring to FIG. 11, the server 2000 may store data collected from a plurality of electronic devices in a data storage 2030. According to an embodiment of the disclosure, the server 2000 may data for each of the plurality of electronic devices. For example, the server 2000 may store data mapped to identification information of an electronic device (e.g., device ID). Also, the server 2000 may store data for each region.

The server 2000 may analyze the data stored in the device data storage 2030. For example, a device data analysis module 2040 of the server 2000 may extract a data pattern from the data collected from the plurality of electronic devices, and may calculate an occurrence frequency of the data pattern in the plurality of electronic devices. Also, the device data analysis module 2040 of the server 2000 may extract a new data pattern (e.g., a data pattern g) from the data collected from the plurality of electronic devices, and may sub-divide a specific data pattern into sub-patterns.

When the device data analysis module 2040 of the server 2000 sub-divides a specific data pattern into sub-patterns, the device data analysis module 2040 may calculate an occurrence frequency of each sub-pattern in the plurality of electronic devices. For example, the device data analysis module 2040 of the server 2000 may sub-divide a data pattern d into a data pattern d1, a data pattern d2, and a data pattern d3, and may calculate an occurrence frequency of the data pattern d1 as 1%, an occurrence frequency of the data pattern d2 as 19%, and an occurrence frequency of the data pattern d3 as 80%.

An importance level database management module 2010 of the server 2000 may update the importance level database 300 based on a result of data analysis performed by the device data analysis module 2040. For example, the importance level database management module 2010 of the server 2000 may define an importance level of the new data pattern g as a sixth level Lv5, which is a highest level, and may add the new data pattern g to the importance level database 300. Also, the importance level database management module 2010 of the server 2000 may add the data pattern d1, the data pattern d2, and the data pattern d3, instead of the data pattern d, to the importance level database 300. The importance level database management module 2010 of the server 2000 may define an importance level of the data pattern d1 as a fifth level Lv4, an importance level of the data pattern d2 as a fourth level Lv3, and an importance level of the data pattern d3 as a third level Lv2 according to an occurrence frequency.

The importance level database management module 2010 of the server 2000 may adjust an importance level of a data pattern f included in the importance level database 300. For example, when an occurrence frequency of the data pattern f increases, the importance level database management module 2010 of the server 2000 may adjust an importance level of the data pattern f from the sixth level Lv5 to the fifth level Lv4.

Accordingly, according to an embodiment of the disclosure, because the server 2000 continuously updates the importance level database 300 by reflecting a result of analyzing data collected from the plurality of electronic devices, data may be efficiently collected from the plurality of electronic devices.

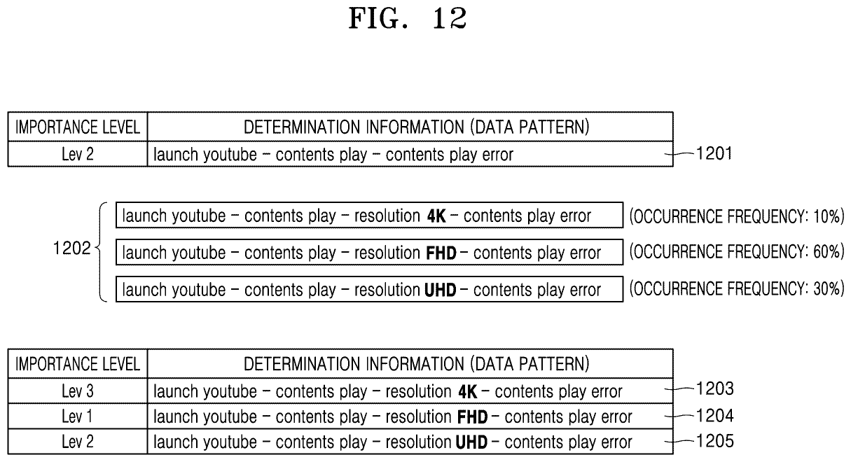

An operation in which the importance level database management module 2010 of the server 2000 sub-divides a data pattern will be described in more detail with reference to FIG. 12.

FIG. 12 is a diagram for describing an operation in which the server 2000 classifies a data pattern into a plurality of sub-patterns, according to an embodiment of the disclosure.

Referring to FIG. 12, a first data pattern 1201 whose importance level is defined as a third level Lev2 may be included in the importance level database 300. For example, the first data pattern 1201 may be a pattern in which a YouTube application is executed, content is played, and an error occurs during content playback (launch youtube-contents play-contents play error).

The server 2000 may collect data related to the first data pattern 1201 from a plurality of electronic devices. The server 2000 may further sub-divide the first data pattern 1201 based on a result of analyzing the data related to the first data pattern 1201 collected from the plurality of electronic devices (1202). For example, the server 2000 may divide the first data pattern 1201 according to a resolution into a first sub-pattern 1203 (e.g., launch youtube-contents play-resolution 4K-contents play error), a second sub-pattern 1204 (e.g., launch youtube-contents play-resolution FHD-contents play error), and a third sub-pattern 1205 (e.g., launch youtube-contents play-resolution UHD-contents play error). In this case, an occurrence frequency of the first sub-pattern 1203 may be 10%, an occurrence frequency of the second sub-pattern 1204 may be 60%, and an occurrence frequency of the third sub-pattern may be 30%.

The server 2000 may determine an importance level according to an occurrence frequency of each sub-pattern. For example, the server 2000 may assign a higher importance level to a sub-pattern having a lower occurrence frequency. That is, the server 2000 may determine an importance level of the second sub-pattern 1204 as a second level Lev1, an importance level of the third sub-pattern 1205 as a third level Lev2, and an importance level of the first sub-pattern 1203 as a fourth level Lev3. As an importance level increases, more detailed data related to a corresponding data pattern may be collected. That is, when an event with an error during playback of content at a resolution of 4 K rarely occurs in the plurality of electronic devices, the server 2000 may determine an importance level of the first sub-pattern 1203 to be higher than that of the second sub-pattern 1204 and the third sub-pattern 1205 in order to collect detailed data for the first sub-pattern 1203.

When the server 2000 sub-divides the first data pattern 1201 into the first sub-pattern 1203, the second sub-pattern 1204, and the third sub-pattern 1205, the server 2000 may update the importance level database 300 to include the first sub-pattern 1203, the second sub-pattern 1204, and the third sub-pattern 1205.

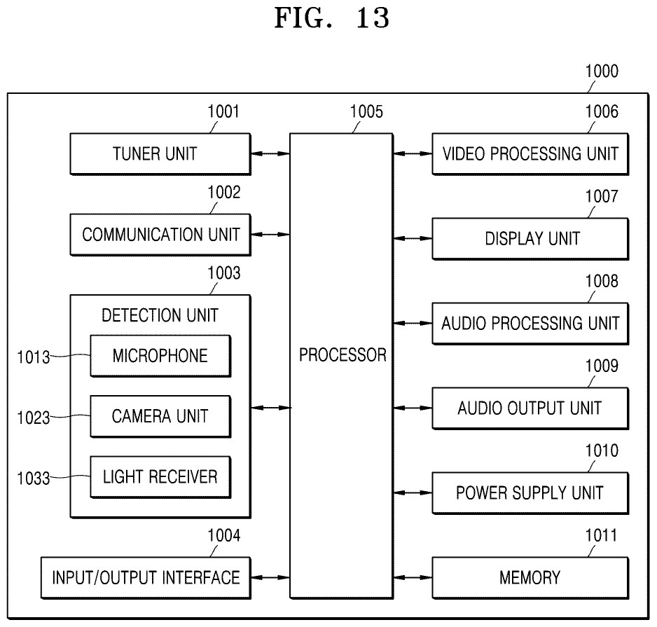

FIG. 13 is a block diagram for describing a function of the electronic device 1000, according to an embodiment of the disclosure.

Referring to FIG. 13, the electronic device 1000 according to an embodiment of the disclosure may include a tuner unit 1001, a communication unit 1002, a detection unit 1003, an input/output interface 1004, a processor 1005, a video processing unit 1006, a display unit 1007, an audio processing unit 1008, an audio output unit 1009, a power supply unit 1010, and a memory 1011. However, not all of the components shown in FIG. 13 are essential components. The electronic device 1000 may include more or fewer components than those illustrated in FIG. 13. For example, the electronic device 1000 may include the memory 1011 and the processor 1005.

Hereinafter, the components will be sequentially described.

The tuner unit 1001 according to an embodiment of the disclosure may tune and select only a frequency of a channel to be received from among many radio wave components through amplification, mixing, and resonance of a broadcast signal that is received by wire or wirelessly. The broadcast signal includes an audio, a video, and additional information (e.g., an electronic program guide (EPG)).

The tuner unit 1001 may receive a broadcast signal from any of various sources such as a terrestrial broadcasting station, a cable broadcasting station, a satellite broadcasting station, or an Internet broadcasting station. The tuner unit 1001 may receive a broadcast signal from a source such as an analog broadcasting station or a digital broadcasting station.

The communication unit 1002 may include one or more components that enable communication between the electronic device 1000 and an IoT device or between the electronic device 1000 and the server 2000. The communication unit 1002 may be also referred to as a communication interface, and may be implemented by any one or any combination of a digital modem, a radio frequency (RF) modem, an antenna circuit, a WiFi chip, and related software and/or firmware. For example, the communication unit 1002 may include a short-range communication unit and a mobile communication unit.

Examples of the short-range wireless communication unit may include, but are not limited to, a Bluetooth communication unit, a Bluetooth low energy (BLE) communication unit, a near-field communication unit, a wireless local area network (WLAN) (Wi-Fi) communication unit, a Zigbee communication unit, an infrared data association (IrDA) communication unit, a Wi-Fi direct (WFD) communication unit, an ultra-wideband (UWB) communication unit, and an Ant+communication unit.

The mobile communication unit transmits and receives a wireless signal to and from at least one of a base station, an external terminal, or a server on a mobile communication network. Here, the wireless signal may include a voice call signal, a video call signal, or various types of data according to text/multimedia message transmission/reception.

The detection unit 1003 may detect a voice, an image, or an interaction of a user, and may include a microphone 1013, a camera unit 1023, and a light receiver 1033.

The microphone 1013 receives an external sound signal and processes the external sound signal into electrical voice data. For example, the microphone 1013 may receive a voice (sound signal) from an external device or a speaker. The microphone 1013 may convert the received voice into an electrical signal and may output the electrical signal to the processor 1005. The user's voice may include, for example, a voice corresponding to a menu or a function of the electronic device 1000. The microphone 1013 may use various noise removal algorithms for removing noise generated during a process of receiving an external sound signal.

The camera unit 1023 may receive an image (e.g., consecutive frames).

The light receiver 1033 receives an optical signal (including a control signal) from an external control device (e.g., a remote controller) through an optical window (not shown) of a bezel of the display unit 1007. The light receiver 1033 may receive an optical signal corresponding to a user input (e.g., a touch, a press, a touch gesture, a voice, or a motion) from the control device. A control signal may be extracted from the received optical signal under the control of the processor 1005.

The input/output interface 1004 may receive a video (e.g., a moving image), an audio (e.g., voice or music), and additional information (e.g., EPG) from the outside of the electronic device 1000 under the control of the processor 1005. The input/output interface 1004 may include any one of a high-definition multimedia interface (HDMI), a mobile high-definition link (MHL), a universal serial bus (USB), a display port (DP), a thunderbolt, a video graphics array (VGA) port, an RGB port, a D-subminiature (D-SUB), a digital visual interface (DVI), a component jack, or a PC port.

The processor 1005 controls an overall operation of the electronic device 1000 and a signal flow between internal components of the electronic device 1000, and performs a function of processing data. When there is the user's input or pre-set and stored conditions are satisfied, the processor 1005 may execute an operating system (OS) and various applications stored in the memory 1011.

The processor 1005 may include one or more processors. The one or more processors included in the processor 1005 may be circuitry such as a system on chip (SoC) or an integrated circuit (IC). The one or more processors included in the processor 1005 may be a general-purpose processor such as a central processing unit (CPU), a microprocessor unit (MPU), an application processor (AP), or a digital signal processor (DSP), a graphics-dedicated processor such as a graphics processing unit (GPU), or a vision processing unit (VPU), an artificial intelligence (AI)-dedicated processor such as a neural processing unit (NPU), or a communication-dedicated processor such as a communication processor (CP). When the one or more processors included in the processor 1005 are AI-dedicated processors, the AI-dedicated processors may be designed with a hardware structure specialized for processing a specific AI model. The processor 1005 may be implemented as a single-core processor or a multicore processor.

The processor 1005 may write data to the memory 1011 or may read data stored in the memory 1011, and particularly, may process data according to predefined operation rules or an AI model by executing a program or at least one instruction stored in the memory 1011.

The processor 1005 may include a random-access memory (RAM) for storing a signal or data input from the outside of the electronic device 1000 or used as a storage area corresponding to various tasks (e.g., image noise removal task) performed by the electronic device 1000, a read-only memory (ROM) for storing a control program for controlling the electronic device 1000, and at least one processor.

The video processing unit 1006 processes video data received by the electronic device 1000. The video processing unit 1006 may perform various image processing such as encoding, decoding, scaling, noise removal, frame rate conversion, and resolution conversion on the video data.

The display unit 1007 may include at least one of a liquid-crystal display unit, a thin-film transistor liquid-crystal display unit, an organic light-emitting diode display unit, a flexible display unit, a three-dimensional (3D) display unit, or an electrophoretic display unit. The electronic device 1000 may include two or more display units 1007 according to an implementation example of the electronic device 1000. When the display unit 1007 and a touch pad have a layer structure to form a touchscreen, the display unit 1007 may be used as an input interface in addition to an output interface.

The audio processing unit 1008 performs processing on audio data. The audio processing unit 1008 may perform any of various processing operations such as decoding, amplification, or noise removal on the audio data. The audio processing unit 1008 may include a plurality of audio processing modules to process audio data corresponding to a plurality of pieces of content.

The audio output unit 1009 outputs an audio included in a broadcast signal received through the tuner unit 1001 under the control by the processor 1005. The audio output unit 1009 may output an audio (e.g., voice or sound) input through the communication unit 1002 or the input/output interface 1004. Also, the audio output unit 1009 may output an audio stored in the memory 1011 under the control by the processor 1005. The audio output unit 1009 may include at least one of a speaker, a headphone output terminal, or a Sony/Phillips digital interface (S/PDIF) output terminal.

The power supply unit 1010 supplies power input from an external power supply source to components in the electronic device 1000 under the control by the processor 1005. Also, the power supply unit 1010 may supply power output from one or more batteries (not shown) located inside the electronic device 1000 to the components under the control by the processor 1005.

The memory 1011 may store various data, a program, or an application for driving and controlling the electronic device 1000 under the control of the processor 1005. The memory 1011 may include a broadcast reception module, a channel control module, a volume control module, a communication control module, a voice recognition module, a motion recognition module, a light reception module, a display control module, an audio control module, an external input control module, a power control module, a power control module of an external device that is wirelessly connected (e.g., Bluetooth), a voice database, a motion database, or the importance level database 300. The modules and databases of the memory 1011 may be implemented as software to perform a mirroring function, a broadcast reception control function, a channel control function, a volume control function, a communication control function, a voice recognition function, a motion recognition function, a light reception control function, a display control function, an audio control function, an external input control function, a power supply control function, or a power control function of an external device wirelessly connected (e.g., Bluetooth) in the electronic device 1000. The processor 1005 may perform each function by using the software stored in the memory 1011.

The memory 1011 may include at least one type of storage medium from among a flash memory type, a hard disk type, a multimedia card micro type, a card type memory (e.g., secure digital (SD) or extreme digital (XD) memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, and an optical disk.

The memory 1011 may not be separately present and may be included in the processor 1005. The memory 1011 may include a volatile memory, a non-volatile memory, or a combination of a volatile memory and a non-volatile memory. A program or at least one instruction for performing operations according to an embodiment of the disclosure may be stored in the memory 1011. The memory 1011 may provide data stored data to the processor 1005 according to a request from the processor 1005.

A block diagram of the electronic device 1000 of FIG. 13 is a block diagram for an embodiment of the disclosure. Each component of the block diagram may be integrated, added, or omitted according to specifications of the electronic device 1000 that is actually implemented. For example, when necessary, two or more components may be combined into one component, or one component may be sub-divided into two or more components. Also, a function performed in each block is intended to describe embodiments, and its detailed operation or device does not limit the scope of the disclosure.

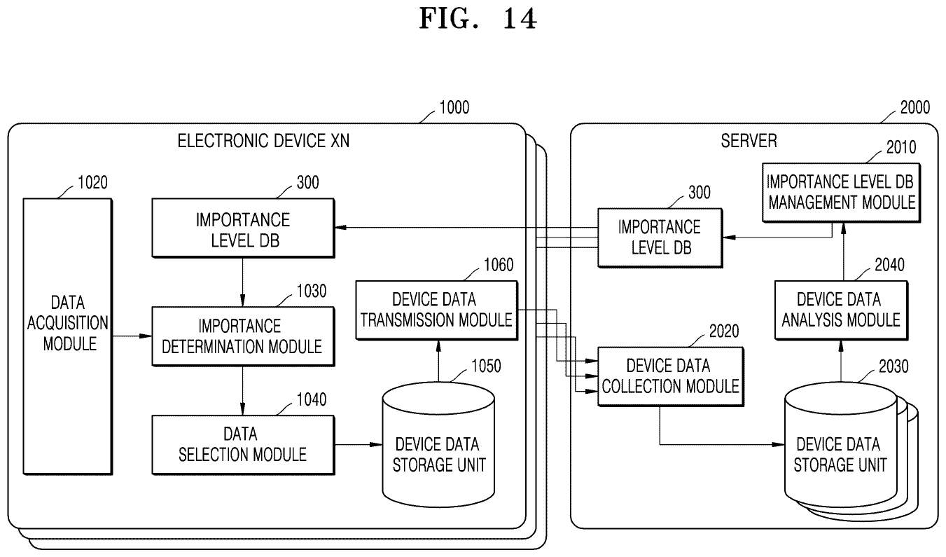

Hereinafter, modules and a database stored in the memory 1011 of the electronic device 1000 will be described in more detail with reference to FIG. 14.

FIG. 14 is a block diagram for describing functions of the electronic device 1000 and the server 2000, according to an embodiment of the disclosure.

Referring to FIG. 14, the electronic device 1000 may include, but is not limited to, the importance level database 300, a data obtaining module 1020, an importance determination module 1030, a data selection module 1040, a device data storage unit 1050, and a device data transmission module 1060. The server 2000 may include, but is not limited to, the importance level database 300, an importance level database management module 2010, a device data collection module 2020, a device data storage unit 2030, and a device data analysis module 2040. Hereinafter, each component will be described.

The importance level database 300 of the electronic device 1000 is a database in which an importance level of each data pattern is defined, and may be received from the server 2000 and stored in the memory 1011. The importance level database 300 may be continuously updated by the server 2000.

When the electronic device 1000 is turned on, whenever an operation event occurs, the data obtaining module 1020 of the electronic device 1000 may obtain data related to the operation event. For example, the data obtaining module 1020 may obtain data logs related to the operation event in real time. The data obtaining module 1020 may generate a data block corresponding to the operation event. For example, the data obtaining module 1020 may generate a data block including data logs related to the operation event.

The importance determination module 1030 of the electronic device 1000 may determine an importance level of each data block based on the importance level database 300 obtained from the server 2000. For example, the importance determination module 1030 may determine whether a data pattern included in each data block matches a data pattern included in the importance level database 300, and may determine an importance level of the data block based on an importance level of the matched data pattern.

The data selection module 1040 of the electronic device 1000 may select a portion of data among entire data included in the data block based on a data collection range corresponding to the importance level of the data block. For example, the data selection module 1040 may select the entire data when the importance level of the data block is a highest level, but may select a small amount of data when the importance level of the data block is low.

The data selection module 1040 of the electronic device 1000 may select a data log corresponding to at least one collection level according to the importance level of the data block. For example, the data selection module 1040 may select data logs corresponding to various collection levels as the importance level of the data block increases. When the importance level of the data block is low, the data selection module 1040 may select data logs corresponding to a minimum collection level. The data selection module 1040 may generate converted data including the data logs selected in the data block. The converted data may be data to be transmitted to the server 2000.

The device data storage unit 1050 of the electronic device 1000 may store the converted data including the data logs selected by the data selection module 1040. According to an embodiment of the disclosure, the electronic device 1000 may store only the data selected among the entire data included in the data block and may discard the remaining data. The device data storage unit 1050 may delete old converted data according to a storage capacity.

The device data transmission module 1060 of the electronic device 1000 may transmit the converted data stored in the device data storage unit 1050 to the server 2000. That is, the device data transmission module 1060 may transmit the converted data including the data logs selected based on the importance level of the data block to the server 2000. The device data transmission module 1060 may transmit the converted data to the server 2000 in real time, or may transmit the converted data with a delay by considering a traffic condition.

The device data collection module 2020 of the server 2000 may collect data (converted data) transmitted from a plurality of electronic devices including the electronic device 1000. According to an embodiment of the disclosure, the device data collection module 2020 may select some electronic devices from among the plurality of electronic devices. In this case, the device data collection module 2020 may collect data from the selected electronic devices.

The device data storage unit 2030 of the server 2000 may store the data (converted data) received from the plurality of electronic devices. The device data storage unit 2030 may store data for each electronic device.

The device data analysis module 2040 of the server 2000 may analyze the data stored in the device data storage unit 2030. The device data analysis module 2040 may extract a data pattern from the data collected from the plurality of electronic devices, and may calculate an occurrence frequency of the data pattern in all of the plurality of electronic devices. The device data analysis module 2040 may sub-divide the data pattern into sub-patterns, and may calculate an occurrence frequency of each sub-pattern in all of the plurality of electronic devices. The device data analysis module 2040 may extract a new data pattern from the data collected from the plurality of electronic devices.

The importance level database management module 2010 of the server 2000 may initially generate an importance level database by defining an importance level of each data pattern. Also, the importance level database management module 21010 may update the importance level database 300 by adjusting an importance level of each data pattern according to an occurrence frequency of each data pattern calculated by the device data analysis module 2040. For example, the importance level database management module 2010 may lower an importance level as an occurrence frequency of a data pattern increases to collect a smaller amount of related data. In contrast, the importance level database management module 2010 may increase an importance level as an occurrence frequency of a data pattern decreases to collect a larger amount of related data.

The server 2000 may transmit the updated importance level database 300 to the plurality of electronic devices including the electronic device 1000. The electronic device 1000 may store the updated importance level database 300, may collect data based on the updated importance level database 300, and may transmit the data to the server 2000.

Accordingly, according to an embodiment of the disclosure, the server 2000 may adjust to collect simple data for a data pattern that repeatedly occurs to reduce traffic, and may adjust to collect detailed data for a new data pattern or a data pattern related to an important function (critical error).

According to an embodiment of the disclosure, the electronic device 1000 that allows the server 2000 to efficiently collect operation information of the electronic device 1000 while reducing traffic may be provided. According to an embodiment of the disclosure, the electronic device 1000 that transmits a portion of data among operation data to the server 2000 based on the database 300 in which an importance of each data pattern is defined may be provided.

According to an embodiment of the disclosure, a method by which an electronic device (1000) transmits data to a server (2000) may include: in response to an occurrence of an operation event, obtaining data related to the operation event (S220); generating a data block including the data related to the operation event (S230); based on a result of comparing a data pattern included in the data block with a database in which an importance level of each data pattern is defined, determining an importance level of the data block (S240); based on a data collection range corresponding to the importance level of the data block, selecting at least some data of entire data included in the data block (S250); and transmitting the selected at least some data to the server (S260).

According to an embodiment of the disclosure, the importance level of each data pattern may be defined based on at least one of an occurrence frequency of each data pattern, an importance of a function related to each data pattern, or a collection amount of each data pattern.

According to an embodiment of the disclosure, wherein the importance level of each data pattern may be defined to increase as the occurrence frequency of each data pattern decreases.

According to an embodiment of the disclosure, the selecting of the at least some data may include selecting at least some data having at least one collection level included in the data collection range.

According to an embodiment of the disclosure, the obtaining of the data related to the operation event include: obtaining data logs related to the operation event; and according to a certain criterion, mapping a collection level to each data log.

According to an embodiment of the disclosure, the data block may include data logs corresponding to a plurality of collection levels.

According to an embodiment of the disclosure, the method may further include determining a data collection range corresponding to the importance level of the data block. According to an embodiment of the disclosure, a number of at least one collection level included in the data collection range may increase as the importance level of the data block increases.

According to an embodiment of the disclosure, the method may further include storing the selected at least some data in a memory.

According to an embodiment of the disclosure, the transmitting of the selected at least some data to the server (2000) may include transmitting the selected at least some data to the server (2000) by considering a traffic condition of the server (2000).

According to an embodiment of the disclosure, the method may further include storing the database, in which the importance level of each data pattern is defined, received from the server (2000); when the electronic device (1000) is turned on, transmitting version information of the database to the server (2000); receiving, from the server (2000), a result of comparing a version of a latest database with a version of the database; and when the version of the latest database is different from the version of the database, downloading the latest database from the server (2000).

According to an embodiment of the disclosure, the determining of the importance level of the data block may include, when the data pattern included in the data block is a new data pattern not defined in the database, determining the importance level of the data block as a highest level.

According to an embodiment of the disclosure, an electronic device (1000) may include a memory (1011) in which a program or at least one instruction is stored; and at least one processor (1005). The program or the at least one instruction stored in the memory (1011), when executed by the at least one processor (1005), may cause the electronic device (1000) to, in response to an occurrence of an operation event, obtain data related to the operation event. The electronic device (1000) may generate a data block including the data related to the operation event. The electronic device (1000) may, based on a result of comparing a data pattern included in the data block with a database (DB) in which an importance level of each data pattern is defined, determine an importance level of the data block, The electronic device (1000) may, based on a data collection range corresponding to the importance level of the data block, select at least some data of entire data included in the data block. The electronic device (1000) may transmit the selected at least some data to a server (2000).

According to an embodiment of the disclosure, the importance level of each data pattern may be defined based on at least one of an occurrence frequency of each data pattern, an importance of a function related to each data pattern, or a collection amount of each data pattern.

According to an embodiment of the disclosure, the electronic device (1000) may select at least some data having at least one collection level included in the data collection range among the entire data included in the data block.

According to an embodiment of the disclosure, the electronic device (1000) may obtain data logs related to the operation event. According to an embodiment of the disclosure, the electronic device (1000) may, according to a certain criterion, map a collection level to each data log.

According to an embodiment of the disclosure, a number of at least one collection level included in the data collection range may increase as the importance level of the data block increases.

According to an embodiment of the disclosure, the electronic device (1000) may store the selected at least some data in the memory (1011).

According to an embodiment of the disclosure, the electronic device (1000) may transmit the selected at least some data to the server (2000) by considering a traffic condition of the server (2000).

According to an embodiment of the disclosure, the electronic device (1000) may store the database in which the importance level of each data pattern is defined, received from the server (2000). The electronic device (1000) may transmit version information of the database to the server (2000) when the electronic device (1000) is turned on. The electronic device (1000) may receive, from the server (2000), a result of comparing a version of a latest database with a version of the database. When the version of the latest database is different from the version of the database, the electronic device (1000) may download the latest database from the server (2000).

According to an embodiment of the disclosure, when the data pattern included in the data block is a new data pattern not defined in the database, the electronic device (1000) may determine the importance of the data block as a highest level.

According to an embodiment of the disclosure, a method by which a server (2000) manages a database may include: generating a database in which an importance level of each data pattern is defined; transmitting the database in which the importance level of each data pattern is defined to an electronic device (1000); collecting data related to an operation event transmitted based on the database from the electronic device (1000); and updating the database by adjusting the importance level of each data pattern based on a result of analyzing the collected data.

According to an embodiment of the disclosure, the updating of the database may include: identifying an occurrence frequency of each data pattern by analyzing the collected data; and adjusting the importance level of each data pattern based on an occurrence frequency of each data pattern.

According to an embodiment of the disclosure, the updating of the database may include: identifying a new data pattern by analyzing the collected data; and setting an importance level of the new data pattern to a highest level.

According to an embodiment of the disclosure, the updating of the database may include: classifying a first data pattern into a plurality of sub-patterns by analyzing the collected data; and defining an importance level corresponding to each of the plurality of sub-patterns.

A machine-readable storage medium may be provided as a non-transitory storage medium. Here, ‘non-transitory’ means that the storage medium does not include a signal (e.g., an electromagnetic wave) and is tangible, but does not distinguish whether data is stored semi-permanently or temporarily in the storage medium. For example, the ‘non-transitory storage medium’ may include a buffer in which data is temporarily stored.

According to an embodiment of the disclosure, the methods according to various embodiments of the disclosure may be provided in a computer program product. The computer program product may be a product purchasable between a seller and a purchaser. The computer program product may be distributed in the form of a machine-readable storage medium (e.g., a compact disc read-only memory (CD-ROM)), or distributed (e.g., downloaded or uploaded) online via an application store or between two user devices (e.g., smartphones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

What is claimed is:

1. A method for transmitting data to a server, the method being performed by an electronic device, the method comprising:
based on an occurrence of an operation event, obtaining data related to the operation event;
generating a data block comprising the data related to the operation event;
comparing a data pattern included in the data block with a database in which importance levels of a plurality of data patterns are defined;
based on a result of the comparison, determining an importance level of the data block;
based on a data collection range corresponding to the importance level of the data block, selecting a portion of data included in the data block; and
transmitting the selected portion of data to the server.

2. The method of claim 1, wherein the importance level of each data pattern of the plurality of data patterns is defined based on at least one of an occurrence frequency of each data pattern of the plurality of data patterns, an importance of a function related to each data pattern of the plurality of data patterns, or a collection amount of each data pattern of the plurality of data patterns.

3. The method of claim 2, wherein the importance level of each data pattern of the plurality of data patterns is defined to increase as the occurrence frequency of each data pattern of the plurality of data patterns decreases.

4. The method of claim 1, wherein the selecting the portion of data comprises selecting data having a collection level included in the data collection range.

5. The method of claim 1, wherein the obtaining of the data related to the operation event comprises:
obtaining data logs related to the operation event; and
according to a certain criterion, mapping a collection level to each data log of the data logs.

6. The method of claim 1, wherein the data block comprises data logs corresponding to a plurality of collection levels.

7. The method of claim 1, further comprising determining the data collection range corresponding to the importance level of the data block,
wherein a number of at least one collection level included in the data collection range increases as the importance level of the data block increases.

8. The method of claim 1, further comprising storing the selected portion of data in a memory.

9. The method of claim 1, wherein the transmitting of the selected portion of data to the server comprises transmitting the selected portion of data to the server by considering a traffic condition of the server.

10. The method of claim 1, further comprising:
receiving, from the server, the database;
storing the database received from the server;
when the electronic device is turned on, transmitting version information of the database to the server;
receiving, from the server, a result of comparing a version of a latest database with a version of the database received from the server; and
when the version of the latest database is different from the version of the database received from the server, downloading the latest database from the server.

11. The method of claim 1, wherein the determining of the importance level of the data block comprises:
when the data pattern included in the data block is a new data pattern not defined in the database, determining the importance level of the data block as a highest level.

12. An electronic device comprising:
memory in which at least one instruction is stored; and
at least one processor operatively coupled to the memory and including a processing circuit,
wherein the at least one instruction stored in the memory, when executed by the at least one processor individually or collectively, causes the electronic device to,
based on an occurrence of an operation event, obtain data related to the operation event;
generate a data block comprising the data related to the operation event;
compare a data pattern included in the data block with a database in which an importance level of a plurality of data patterns are defined;
based on a result of the comparison, determine an importance level of the data block;
based on a data collection range corresponding to the importance level of the data block, select a portion of data included in the data block; and
transmit the selected portion of data to a server.

13. The electronic device of claim 12, wherein the importance level of each data pattern of the plurality of data patterns is defined based on at least one of an occurrence frequency of each data pattern of the plurality of data patterns, an importance of a function related to each data pattern of the plurality of data patterns, or a collection amount of each data pattern of the plurality of data patterns.

14. The electronic device of claim 12, wherein to select the portion of data comprises to select data having a collection level included in the data collection range.

15. The electronic device of claim 12, wherein the at least one instruction stored in the memory, when executed by the at least one processor individually or collectively, causes the electronic device to:
obtain data logs related to the operation event, and,
according to a certain criterion, map a collection level to each data log of the data logs.

16. The electronic device of claim 12, wherein a number of at least one collection level included in the data collection range increases as the importance level of the data block increases.

17. The electronic device of claim 12, wherein the at least one instruction stored in the memory, when executed by the at least one processor individually or collectively, causes the electronic device to store the selected portion of data in the memory.

18. The electronic device of claim 12, wherein to transmit of the selected portion of data to the server comprises to transmit the selected portion of data to the server by considering a traffic condition of the server.

19. The electronic device of claim 12, wherein the at least one instruction stored in the memory, when executed by the at least one processor individually or collectively, causes the electronic device to:
receive, from the server, the database;
store the database received from the server;
when the electronic device is turned on, transmit version information of the database to the server;
receive, from the server, a result of comparing a version of a latest database with a version of the database received from the server; and
when the version of the latest database is different from the version of the database received from the server, download the latest database from the server.

20. The electronic device of claim 12, wherein to determine of the importance level of the data block comprises to:
when the data pattern included in the data block is a new data pattern not defined in the database, determine the importance level of the data block as a highest level.
